(19) United States
(12) Patent Application Publication
(10) Pub. No.: US 2002/0056047 A1
(43) Pub. Date: May 9, 2002

(54) System and method for communicating software debug, diagostic and maintenance information between devices

(76) Inventor: Larry L. Lehman, Palo Alto, CA (US)

Correspondence Address: FAY KAPLUN & MARCIN, LLP, 17th Floor, 100 Maiden Lane, New York, NY, 10038, US

(21) Appl. No.: 09/953,705

(22) Filed: Sep. 17, 2001

Related U.S. Application Data
(60) Provisional application No. 60/233,036, filed on Sep. 15, 2000.

(51) Int. Cl. G06F 11/30; G06F 11/00

(52) U.S. Cl. 713/200; 714/38

(57) ABSTRACT

A system, comprising a target server configured to receive a request from a software tool and format a protocol request corresponding to the request, the protocol request including a request fixed length leader having a predetermined maximum size and a target agent configured to receive the protocol request from the target server into a communication buffer and send an instruction to a target processor to perform a function corresponding to the request, wherein the communication buffer is one of equal to and larger than the predetermined maximum size.

### INCORPORATION BY REFERENCE

This application claims the benefit of U.S. Provisional Patent Application No. 60/233,036 filed on Sep. 15, 2000 and entitled “Target Debug Protocol” and is expressly incorporated herein, in its entirety, by reference.

### BACKGROUND INFORMATION

Many products contain processors or controllers that execute software programs in order to provide functionality to the users of the products. Examples of products that may contain such processors running application software include wireless telephones, personal digital assistants (“PDAs”), computer networking products, home appliances, office products, factory automation products, automotive components, security devices, etc. These products may be referred to as embedded devices because they contain embedded processors having operating systems which are the main control programs that schedule tasks, manage storage, and handle communication with peripherals. Examples of application programs that may be loaded on these devices include word processing, web page display, electronic mail, control functionality software, etc.

Developers are constantly writing new application programs and improving existing application programs to provide additional functionality for users of the devices. Before a new application program is released to the public, it generally goes through a rigorous development process to ensure that the product is released with the fewest possible number of errors. The software code for application programs may be thousands of lines of code with each section of code being written by a different developer or team of developers. Checking each line of code by hand would be virtually impossible due to the magnitude and complexity of the code. A debugging program aids a developer in searching the lines of code for errors or bugs and reports these errors to the developer. Debugging programs may find the errors by stepping through the application programs one operation at a time. The developers then may correct the errors found by the debugging program and continue to test the application program to determine if it is accomplishing the intended goals.

In an application program that must run continuously for long periods of time, program errors may only become evident after an extended period of operation. Additionally, error may only become evident once the application is run in conjunction with the actual hardware platform that will ultimately incorporate the application. Detecting such errors often requires the developer to communicate with a running device and retrieve diagnostic information from the device. Furthermore, some embedded applications may require the developer to calibrate or change selected parameters in the running program for the purpose of tuning application program performance. After a thoroughly tested embedded application is put into service, the need may still arise in the future to connect to the device for maintenance purposes and patch or update the functionality of the application program.

### SUMMARY OF THE INVENTION

A system, comprising a target server configured to receive a request from a software tool and format a protocol request corresponding to the request, the protocol request including a request fixed length leader having a predetermined maximum size and a target agent configured to receive the protocol request from the target server into a communication buffer and send an instruction to a target processor to perform a function corresponding to the request, wherein the communication buffer is one of equal to and larger than the predetermined maximum size.

Furthermore, a method, comprising the steps of formatting a protocol request corresponding to a request from a software tool, the protocol request including a request code corresponding to the request, transmitting the protocol request, receiving the protocol request, determining the request from the request code and instructing a target processor to take an action based on the request.

### BRIEF DESCRIPTION OF DRAWINGS

FIG. 1 shows a first exemplary arrangement for communicating between a host device and a target device according to the present invention;

FIG. 2 shows a block diagram of an exemplary data transfer between a host device and a target device via a target server and target agent according to the present invention;

FIGS. 3a-e show exemplary data structures for a protocol message according to the present invention;

FIG. 4 shows an exemplary process for exchanging protocol messages between devices according to the present invention;

FIGS. 5a-b show an exemplary protocol request and protocol reply for a read register request according to the present invention.

FIGS. 6a-b show an exemplary protocol request and protocol reply for a write memory request according to the present invention.

FIGS. 7a-b show an exemplary protocol request and protocol reply for a Ping request according to the present invention;

FIG. 8 shows a block diagram of an exemplary messaging session between a target server and a target agent according to the present invention;

FIG. 9 shows a second exemplary arrangement for communicating between a host device and a target device according to the present invention.

### DETAILED DESCRIPTION

The present invention may be further understood with reference to the following description of preferred exemplary embodiments and the related appended drawings, wherein like elements are provided with the same reference numerals. When developers are writing application software for embedded devices, the development work is generally performed on a traditional computing device (e.g., a personal computer (“PC”), workstation, etc.). During the development stage the application software may be loaded from the development device (the “host”) to the embedded device or an equivalent hardware platform for software development (the “target”) for debugging and testing purposes. The application software is executed by the target, which sends messages back to the host so that the developer may remotely debug, calibrate or maintain the application software. The exemplary embodiments of the present invention allow for an efficient manner of exchanging messages between the host and the target. In this description, the terms message, protocol message, request, reply and combinations thereof are used interchangeably to generally refer to the exchange of information between devices (e.g., host device and target device).

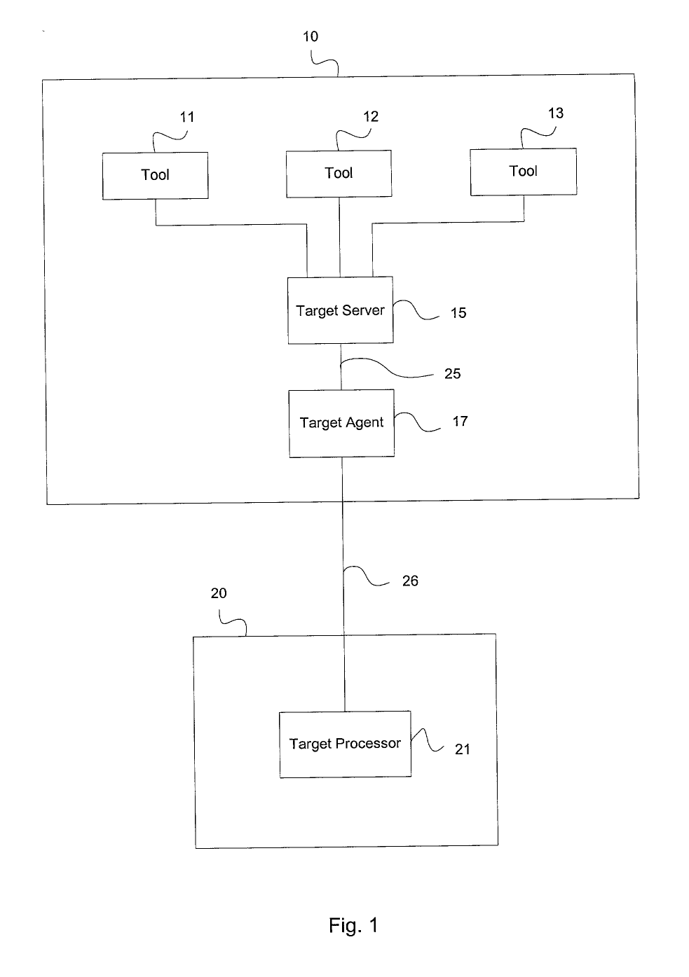

FIG. 1 shows a first exemplary arrangement for communicating between host device 10 and target device 20. In this exemplary arrangement, host device 10 may be, for example, running Integrated Development Environment (“IDE”) software having application tools 11-13, target server 15 and target agent 17. An exemplary IDE is the Tornados integrated development environment sold by Wind River Systems, Alameda, Calif. Application tools 11-13 may be tools included in the IDE software package or they may be third party tools provided, for example, as plug-ins to the IDE software. Exemplary tools include software loaders/launchers, debuggers, command line interface (“CLI”) shells, browsers, calibration tools, maintenance tools, etc. Tools 11-13 aid the developer in writing, debugging, testing, calibrating and maintaining the application software for target device 20. In the exemplary embodiment of FIG. 1, it may be considered that tool 11 is a debugging tool or program.

Target server 15 facilitates communication between the tools 11-13 of the IDE and target device 20. Each of tools 11-13 may request information from and/or send information to target device 20 via target server 15. In turn, target server 15 communicates with target agent 17 over any serial byte stream communication channel 25 (e.g., RS-232, Ethernet, Internet Protocol (“IP”), Controller Area Network (“CAN”), etc.) using the message protocol according to the present invention. In the following descriptions which refer to target server 15, it should be understood that it is equally viable for a tool 11 supporting the described message protocol to communicate directly with target agent 17 over communication channel 25 without requiring the services of an intermediate target server.

Target agent 17 is a message and event handler that operates in the background as the application software is running on target device 20. Target agent 17 may be a separate software module or may, alternatively, be contained as a sub-component within a larger software module. In the present example, target agent 17 communicates directly with processor 21 of target device 20 via hardware communication link 26 (e.g., Background Debug Mode (“BDM”), IEEE 1149.1-Standard Test Access Port and Boundary-Scan Architecture (“JTAG”), IEEE-ISTO 5001™-The Nexus 5001 Forum™ Standard for a Global Embedded Processor Debug Interface and any required supporting host software. Target agent 17 listens for events from processor 21 of target device 20 or requests for information from tools 11-13. When target agent 17 detects an event or request, it allows the tool (e.g., debugger program 11) to take operational control of the target processor 21 of target device 20. In this manner, the exemplary debugger program 11 resident on host device 10 may be used to remotely debug the application software resident on target device 20. Target agent 17 relays this information (e.g., events) to debugger program 11 via target server 15.

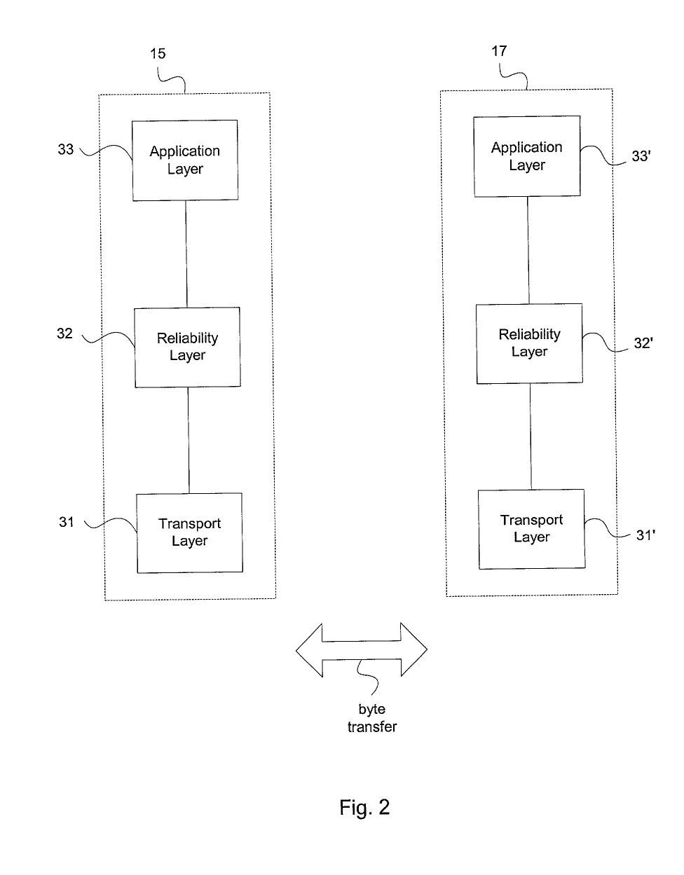

FIG. 2 shows a block diagram of an exemplary data transfer between host device 10 and target device 20 via target server 15 and target agent 17. As will be described in greater detail below, target agent 17 may reside on host device 10 or on target device 20. Target agent 17 is responsible for receiving and processing protocol request messages from target server 15. The protocol request messages are generated by the tools 11-13 in host device 10. Examples of protocol request messages include requests for debug actions generated by a debugging tool. For each request that target agent 17 receives, it causes the requested action to be taken on the target processor 21. In the exemplary arrangement of FIG. 1 where target agent 17 is resident on host device 10, the requested action may be invoked indirectly via commands to controlling software for a hardware in-circuit emulator, probe, or any other target link. The arrangement of FIG. 1 is typical where target device 20 has on-chip debug hardware and emulator support. Thus, whether target agent 17 resides on host device 10 or target device 20, the messages received by target agent 17 may be considered as received by target device 20. Therefore, when this description discusses the transfer of information between a target server and a target agent, it may be considered that the information is being transferred between devices regardless of where the target agent is residing.

Target server 15 is shown with exemplary communication software layers 31-33 (i.e., transport layer 31, reliability layer 32 and application layer 33). Target agent 17 is shown with corresponding exemplary communication software layers 31′-33′. Those skilled in the art will understand that the layering model shown in FIG. 2 is only exemplary and that the devices may implement communication software containing any number of layers. Other exemplary layers may include a security layer, a presentation layer, a session layer, a network layer, a data link layer, a physical layer, etc. Each software layer communicates with its peer layer in the other device through the use of a protocol. A protocol specifies a common set of rules for data transfer between various devices. The exemplary embodiment of the present invention describes an extensible application layer message protocol for remote debugging of the software. Thus, according to the exemplary embodiment of the present invention, the message formatting for relaying debugging information between host device 10 and target device 20 takes place via applications layers 33 and 33′. These application layers can be implemented over any underlying communication layers that support reliable byte stream transport of data between devices. Those of skill in the art will understand that the messaging protocol of the present invention is not limited to messaging via the application layer or limited for use in debugging applications. The present invention may be used in any system where a protocol is used for messaging between devices.

The protocol according to an exemplary embodiment of the present invention is based upon request/reply messages. Referring to FIG. 1, target server 15 issues request messages generated by tools 11-13 to target agent 17 which is monitoring the real time operation of target device 20. Target agent 17 responds to each request message issued by target server 15 with a reply message. The protocol messages may be encoded into a serial byte stream using standard encoding, for example, External Data Representation (“XDR”) encoding as defined in Request for Comment (“RFC”) 1832. This encoding allows for the protocol messages to be independent of the machine or device hardware. Such encoding is often referred to as “big-endian” byte order which may be used to achieve processor byte order independence.

When one of tools 11-13 desires to send a request to target device 20, application layer 33, which may reside within target server 15, receives the request and formats the request using the protocol of the present invention into, for example, a serial byte stream using XDR encoding. The message is then passed to reliability layer 32 which may encode additional information to insure reliable data transfer, for example sequence numbers and checksums. The message is then passed to transport layer 31 which again encodes additional information to allow the message to be directed to the correct destination. For example, transport layer 31 may be an Internet Protocol (“IP”) layer which encodes information such as the destination IP address. The serial byte stream is then physically transferred to the target agent 17.

When target agent 17 receives the message, it is initially passed up to transport layer 31′ which retrieves the data added by its peer layer in target server 15, transport layer 31, and passes the remaining data up to reliability layer 32′. Similarly, reliability layer 32′ retrieves the information added by its peer layer in target server 15, reliability layer 32, and passes the message up to application layer 33′. Upon receiving and processing the request, target agent 17 determines the action that should be taken by target processor 21 and instructs the target processor 21 to take the requested action. Target agent 17 then receives the result of the action from target processor 21 and formats a reply to the request via application layer 33′ and sends the reply back to target server 15 (in the same manner that target server 15 sent the original request to target agent 17). Target server 15 then relays the information to the tool that requested the action.

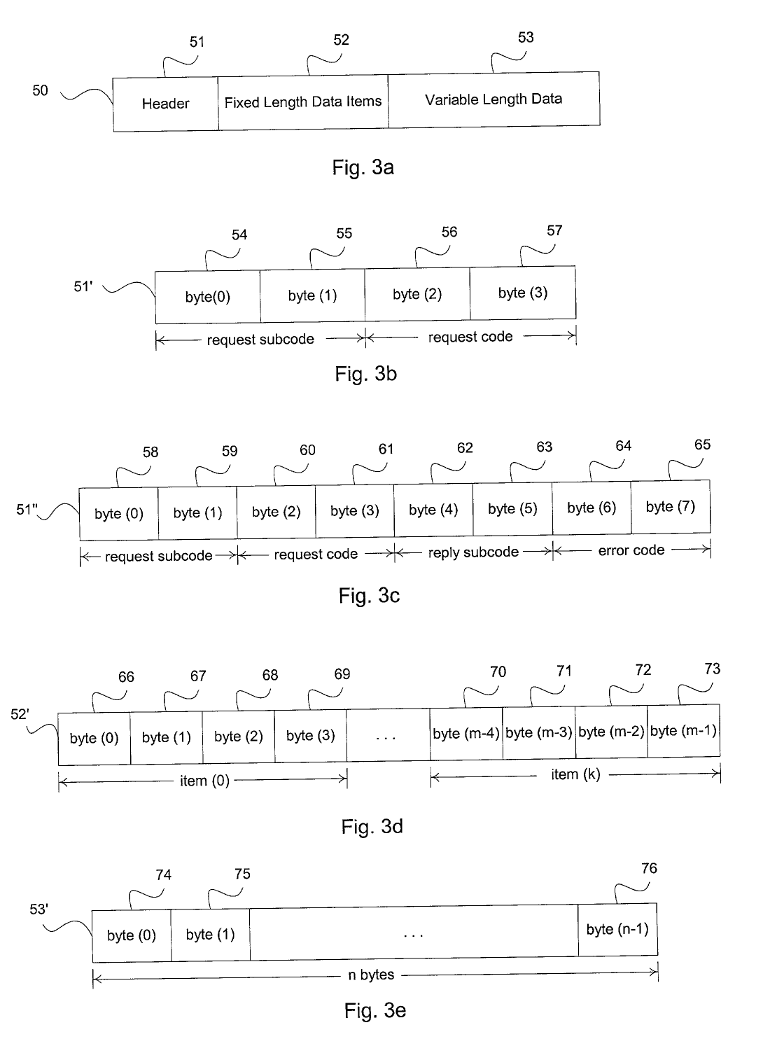

FIG. 3a shows an exemplary data structure 50 for a protocol message according to the present invention. Exemplary data structure 50 has three components, header 51, fixed length data area 52 and variable length data area 53. The data contained within each of components 51-53 will be described in greater detail below. A protocol message according to the present invention may contain one, two or three of the components 51-53 of data structure 50. Each protocol message will contain header 51 because that component includes the request code(s) which controls interpretation of the subsequent components in a message. There is no set length for data structure 50. However, the combination of header 51 and fixed length data area 52 of data structure 50 typically will not exceed the maximum transfer unit (“mtu”) message buffer size of target agent 17. Header 51 combined with fixed length data area 52 may be considered a fixed length leader portion of a protocol message. This fixed length leader portion of a message may be encoded in “big-endian” order to achieve processor byte order independence. As explained in more detail below, variable length data area 53 is not encoded, but is simply raw data that may be streamed between host device 10 and target device 20. Thus, the size of data structure 50 does not limit the size of the entire message, as variable length data area 53 may be any size. The mechanism for transferring variable length data area 53 will be discussed in greater detail below.

Generally, embedded devices such as target device 20 have limited computing resources (e.g., processor speed, random access memory (“RAM”), flash memory, etc.) and therefore, it may be important to implement software components with as little memory footprint as possible. Thus, developers may seek to limit the amount of memory space that a software component such as target agent 17 occupies on target device 20 or host device 10. One manner of limiting the amount of space occupied by target agent 17 is to limit the mtu buffer size. According to the exemplary embodiment of the present invention, the mtu buffer size need only be large enough to accommodate the header 51 and fixed length data area 52, both of which have a small predetermined maximum size. Thus, the communication buffers of target agent 17 may be statically allocated to accommodate this small predetermined maximum size, eliminating the need for dynamic memory allocation and associated memory management runtime support libraries.

FIG. 3b shows an exemplary request header 51′. A protocol message going from target server 15 to target agent 17 may be considered a request protocol and will include a request header 51′. Similarly, a protocol message going from target agent 17 to target server 15 may be considered a reply protocol and will include a reply header 51″ (described below with reference to FIG. 3c). Those skilled in the art will understand that these directional terms are only used for convenience and that a protocol message going from target server 15 to target agent 17 may be in reply to a request from target agent 17, but it will still be termed a request protocol because of the direction it is going. Exemplary request header 51′ is shown as having four bytes 54-57. Byte(0) 54 and byte(1) 55 may contain request subcodes and byte(2) 56 and byte(3) 57 may contain request codes. The request codes and subcodes are the codes that indicate to target agent 17 the action requested by target server 15. Exemplary codes and subcodes will be described below. Every request will have a request code, but the request subcode is optional and is based on the information that is conveyed by the request. A four byte request header is only exemplary and any size request header may be selected.

FIG. 3c shows an exemplary reply header 51″.As described above, a protocol message going from target agent 17 to target server 15 may be considered a reply protocol and will include a reply header 51″.Exemplary reply header 51″ is shown as having eight bytes 58-65. Byte(0) 58 and byte(1) 59 may contain request subcodes and byte(2) 60 and byte(3) 61 may contain request codes. The request codes and subcodes contained in the reply header 51″ are the same as the request codes and subcodes contained in request header 51′. For example, when target agent 17 receives a protocol request from target server 15 in the format of data structure 50 including request header 51′, target agent 17 decodes the request and instructs target processor 21 to perform the requested action. When target agent 17 is formatting the protocol reply in the format of data structure 50, target agent 17 includes the request code and subcode (if applicable) that corresponds to the protocol request in reply header 51″. In addition, reply header 51″ also may include reply subcode in byte(4) 62 and byte(5) 63 and error code in byte(6) 64 and byte(7) 65. Reply subcode is similar to the request subcode and is optional. Error code may be an indication of whether the request was successfully completed by the target processor 21 or may be an indication that a failure occurred and the reason for the failure. Exemplary error codes for exemplary requests are described below. Those skilled in the art will understand, once again, that the eight byte length of reply header 51″ is only exemplary and that any length of reply header may be used. For example, a reply header may not include the request code and subcode corresponding to the request header (e.g., only a two byte reply subcode and two byte error code may be included in the reply header).

FIG. 3d shows an exemplary fixed length data area 52′. In this example, fixed length data area 52′ is m bytes long, where m may be any integer value. The first four bytes 66-69 may contain the first item (e.g., item(0)) of fixed length data in the protocol message. The last four bytes 70-73 may contain the last item (e.g., item(k) of fixed length data in the protocol message. The number of data items (k) within a fixed length data area 52′, as well as the order of the data items, may be predetermined based on the type of message (e.g., write register, read memory, etc.). Examples of fixed length data items will be described below.

In this example, each data item (e.g., item(0) and item(k)) is four bytes in length. This length is only exemplary and any length may be selected for the individual data items. A four byte length may be useful for encoding (e.g., XDR encoding) to avoid the use of padding bytes. In the examples described above with respect to FIGS. 3a-d, a developer may select thirty-two bytes as an appropriate mtu buffer size. Specifically, header 51 may occupy either a four byte request header 51′ or an eight byte reply header 51″, leaving either twenty-eight bytes or twenty-four bytes, respectively, to accommodate fixed length data area 52. Those of skill in the art will understand that a thirty-two byte mtu buffer size is only exemplary. Any length (larger or smaller) may be used based on the resources of the target agent 17. In addition, there may be protocol messages that do not need to use the entire exemplary allocation of thirty-two bytes. For example, a simple protocol request may only use the four byte request header 51′ to communicate the entire request.

FIG. 3e shows an exemplary variable length data area 53′. In this example, variable length data area 53′ is n bytes long (bytes 74-76). The data that is sent in variable length data area 53′ is raw data that does not need to be interpreted, and therefore it can be sent as streaming data. The streaming data does not need to be decoded by any intervening software (e.g., target agent 17) meaning that the data can go directly to or from target processor 21 in the endian byte order usable by target processor 21. A protocol message is not required to have variable length data area 53′ because not every request or reply will contain variable length data. Where variable length data area 53′ is included in a message, one data item in fixed length data area 52 may indicate and/or may be used to calculate the length in bytes of variable length data area 53′. For example, a data item of fixed length data area 52 may indicate that n=32 (and thus indicate the presence of variable length data). Target agent 17 may decode this data item in fixed length data area 52 and then indicate to target processor 21 that it should be prepared to receive thirty-two bytes of streaming information. Specific examples of variable length data items will be described below.

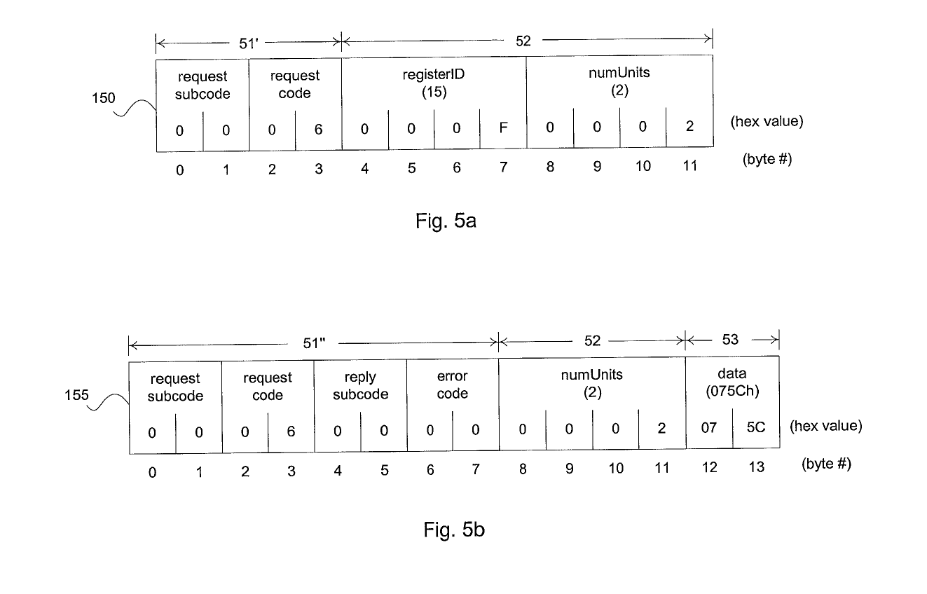

In a first example, a tool 11-13 of host device 10 may desire to read a value from a specific register of target device 20. The tool will send the request to target server 15 which will format and encode the request in, for example, the format of data structure 50. In this example, target server 15 will encode the type of request (e.g., read from a register) in header 51 of data structure 50. Target server 15 may also encode the specific register to read from and the number of bytes that should be read in fixed length data area 52 of data structure 50. FIG. 5a shows an exemplary protocol request 150 that may be formatted by target server 15 in response to tools 11-13 requesting the read register function. FIG. 5a shows protocol request 150 including request header 51′ and fixed length data area 52. Request header 51′ is four bytes in length and has request subcode and request code. The exemplary values for the request subcode (00) and the request code (06) are shown in hexadecimal format. Thus, in this example, there are no request subcodes (i.e., subcode (00)) and the exemplary request code value for the read register function is (06). Header 51′ is in the request format described with reference to FIG. 3b because the protocol message will be going from target server 15 to target agent 17. Fixed length data area 52 is eight bytes in length and the first four byte data item indicates the register identification (“registerID”) from which the data should be read (e.g., registerID (15) which in hexadecimal is (000F)). The second four byte data item in fixed length data area 52 indicates the number of bytes (“numUnits”) which should be read from the specified register (e.g., numUnits=2 bytes which in hexadecimal is (0002)). In this example, header 51′ and fixed length data area 52 contain the entire message that is bound for target device 20 without the need for variable length data area 53.

As described above, target server 15 may encode exemplary protocol message 150 (e.g., XDR encoding) and send protocol message 150 to target agent 17 in, for example, the layering manner described above. When target agent 17 receives protocol message 150, it decodes the message and instructs target processor 21 to perform the requested action (e.g., read the requested register). Thus, in this example, target agent 17 decodes header 51′ and determines that there are no request subcodes (00) and the request code value is (06). Target agent 17 is loaded with software that understands that the request code value (06) means a read register request. Target agent 17 then decodes fixed length data area 52 and determines the specific register which should be read (e.g., registerID(15)) and the number of bytes that should be read from the register (e.g., numUnits=2).

Those of skill in the art will understand that the order of the encoding and decoding is not important and there may be numerous methods of determining the order of the information in the encoded message of data structure 50. For example, the request subcode may be contained in the two most significant bytes of request header 51′, the request code may be contained in the two least significant bytes of header 51′ and the specific information for the request may be contained in the least significant bytes of fixed length data area 52.

After target agent 17 has received and decoded the protocol request and instructed target processor 21 to take the requested action, target agent 17 receives the result of the action from target processor 21. For example, target processor 21 may indicate that the requested action of reading from a specific register was successfully accomplished, that the requested register does not exist, that the requested register size could not be processed, etc. Target agent 17 then encodes a protocol reply to send back to target server 15 to indicate to the requesting tool 11-13 the status of the request. For example, if the reading of the register was successful, target agent 17 may encode a message indicating the register was read and the data from the register is being sent to target server 15. FIG. 5b shows an exemplary protocol reply 155 that may be formatted by target agent 17 in response to protocol request 150. Protocol reply 155 includes reply header 51″, fixed length data area 52 and variable length data area 53. The variable length data area 53 may be streamed back to target server 15 and does not need to be stored in the communication buffer of target agent 17 or encoded by target agent 17 because it is raw data that can be directly transferred from target processor 21.

Continuing with the example of protocol reply 155, reply header 51″ is eight bytes in length and has request subcode (00), request code (06), reply subcode (00) and error code (00) shown in hexadecimal format. The values for the request code (06) and request subcode (00) are the same as those in protocol request 150. There are no reply subcodes (i.e., subcode (00)) or error codes (i.e., error code (00)). The lack of an error code may indicate that the operation was successfully carried out by target processor 21. If the reply contains an error code indicating that the requested action was not carried out, there may be an indication to a user or developer that a corresponding requested action failed. The system may correlate the request and the error code so the user or developer may then take corrective action to fix the failure. The corrective action may also be taken automatically by one of the tools 11-13 which may have error detection and recovery routines. Header 51″ is in the reply format described with reference to FIG. 3c because the protocol message will be going from target agent 17 to target server 15. Fixed length data area 52 is four bytes in length and the data item indicates the number of register bytes (“numUnits”) which were read from the specified register (e.g., numUnits=2 bytes which in hexadecimal is (0002)). Variable length data area 53 is two bytes and contains the raw data from the two register bytes that were read (e.g., 075C in hexadecimal). In this example, header 51″ and fixed length data area 52 do not contain the entire message that is bound for target server 15. Thus, when target server 15 receives and decodes protocol reply 155, target server 15 is prepared to receive the additional two bytes of raw information in variable length data area 53 directly from target processor 21. When this information is received, the request/reply cycle of the messaging is complete.

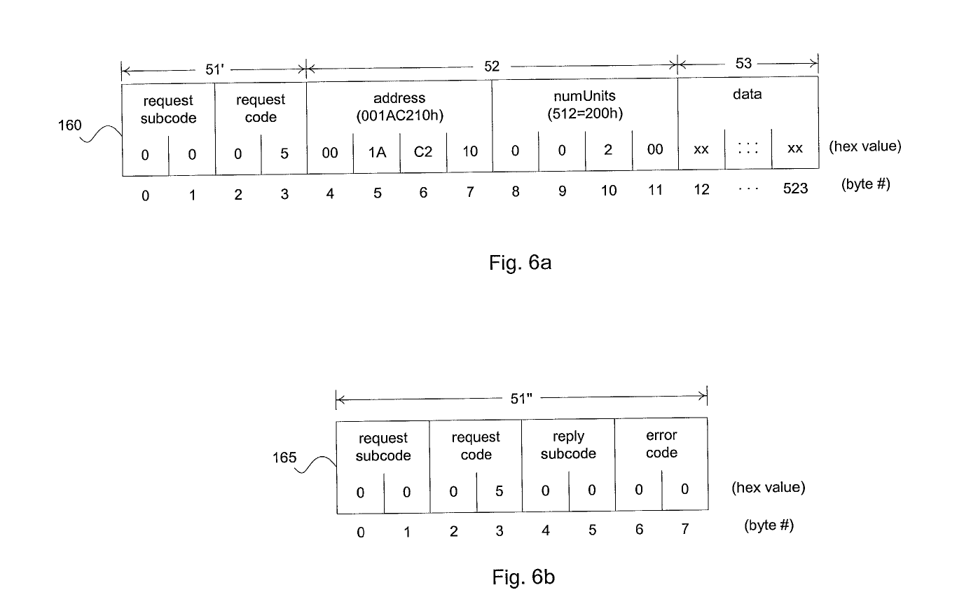

In a second example, a tool 11-13 of host device 10 may desire to write information to the memory of target device 20. In this example, the information that the tool desires to write to the memory of target device 20 may be significantly larger than the mtu of target agent 17. However, target server 15 may still format and encode the request in the format of data structure 50. FIG. 6a shows an exemplary protocol request 160 that may be formatted by target server 15 in response to tools 11-13 requesting the write memory function. Protocol request 160 includes request header 51′, fixed length data area 52 and variable length data area 53. Once again, the actual protocol message that will be encoded by target server 15 will be limited to request header 51′ and fixed length data area 52 because variable length data area 53 will be streamed from target server 15 to target processor 21. Request header 51′ is four bytes in length and has exemplary values for the request subcode (00) and the request code (05) shown in hexadecimal format. Thus, in this example, there are no request subcodes (i.e., subcode (00)) and the exemplary request code value for the write memory function is (05). Fixed length data area 52 is eight bytes in length and the first four byte data item indicates the memory location (“address”) where the data should begin to be written (e.g., address=001AC210h in hexadecimal). The second four byte data item in fixed length data area 52 indicates the number of bytes (“numUnits”) which should be written into memory (e.g., numUnits=512 bytes which in hexadecimal is (00200h)). Variable length data area 53 contains the actual 512 bytes of raw data that will be streamed to target processor 21. In this example, header 51′ and fixed length data area 52 do not contain the entire message that is bound for target device 20, but do contain an indication of the entire length of the request. 91 When target agent 17 receives protocol request 160, it decodes the message and instructs target processor 21 to write to a specific memory location. Target agent 17 also indicates to target processor 21 that the amount of streaming raw information it will receive to write to memory is 512 bytes. Thus, in this example, target agent 17 decodes the request codes and subcodes in header 51′ and determines that the requested action is for target processor 21 to write to memory. Target agent 17 then decodes the first data item in fixed length data area 52 and determines the specific memory location to which the information should be written (e.g., 001AC210h) and finally, decodes the second data item in fixed length data area 52 and determines the size of the information that should be written to memory (e.g., 512 bytes). Target server 15 may then stream the variable length data area 53 one byte at a time directly to the target processor 21 for writing to memory because target agent 17 indicates to target processor 21 the number of bytes that will be transferred. Thus, the small communication buffer of target agent 17 (e.g., thirty-two bytes) is able to handle protocol requests that are much larger than the buffer because the specified length of the message is contained in the bytes of the fixed length leader portion of the message that fit into the communication buffer. The remaining bytes of the protocol request may completely bypass the communication buffer of target agent 17. This allows the communication buffer of target agent 17 to remain small regardless of the size of data that needs to be transferred. Additionally, this method of transferring messages larger than the communication buffer of target agent 17 provides for fast data transfer since communication handshaking between the communicating devices (e.g., target server 15 and target agent 17) is kept to a single request/reply cycle.

After the information is written into the memory of target device 20, target agent 17 formats a reply message to send to target server 15 to indicate the status of the request. FIG. 6b shows an exemplary protocol reply 165 that may be formatted by target agent 17 in response to the write memory request. Protocol reply 165 includes reply header 51″ having request subcode, request code, reply subcode and error code. The request subcode (00) and the request code (05) are the same as those in protocol request 160. There is no reply subcode (00) and no error code (00) indicating that the write memory function was successfully completed by target processor 21. In this example, the entire protocol reply 165 is contained in header 51″ without the need for fixed length data area 52 or variable length data area 53. When target server 15 receives protocol reply 165 it will decode the message and indicate to the requesting tool that the write memory function has been successfully completed. This completes the request/reply cycle of this message.

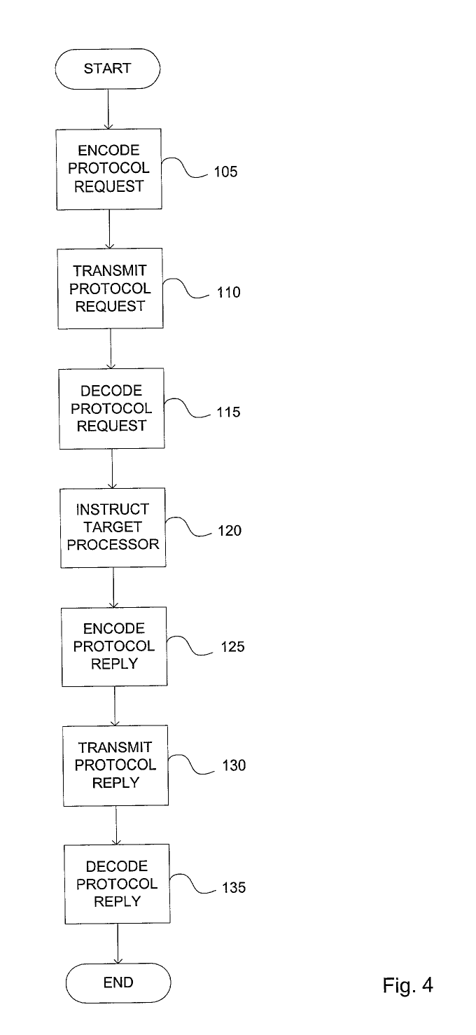

FIG. 4 shows an exemplary process 100 for exchanging protocol messages between devices. In step 105 the target server 15 encodes the protocol request into, for example, the format of data structure 50. In step 110, the protocol request is transmitted from target server 15 to target agent 17 via, for example, the layering model described above. When target agent 17 receives the protocol request, it decodes the request in step 115 to determine the requested action. The protocol request received by target agent 17 may be an entire fixed length request (as described in the first example above) or may be the initial fixed length portion of a variable length request (as described in the second example above). The target agent 17 then instructs the target processor 21 in step 120 to take the action requested in the protocol request (e.g., read/write memory, read/write register, etc.). As described above, this action may include preparation to receive additional streaming bytes of information. Target processor 21 then takes the requested action, if possible, and reports the result of the action back to target agent 17 which then encodes a protocol reply in step 125 to indicate the status of the requested action. Target agent 17 then transmits the protocol reply back to target server 15 in step 130. Target server 15 receives and decodes the protocol reply in step 135 and reports the result of the requested action back to the requesting tool.

Referring back to FIG. 3a, exemplary data structure 50 for a protocol message according to the present invention may be used to define an extensible messaging specification. As described above, two bytes in header 51 of a protocol message with the format of data structure 50 may be used to identify the type of request. Two bytes results in 65,536 (2¹⁶) different bit combinations which may be used to identify a corresponding number of requests if the two bytes are dedicated to request identification. However, those skilled in the art will understand that identifying and providing corresponding source and/or object code for that number of requests could overwhelm the memory space and processing power of such a target device 20 (as in the case of constrained environments). Developers may select a core number of requests that are important for the particular function for which the tool or tools on the host device may be used. For example, there may be a set of requests that are important for debugging operations that a developer may select to include in the messaging protocol. Examples of such debugging requests are described in greater detail below. When the developer includes a set of requests in the protocol, support for these requests in the form of source or object code is loaded into the device which needs to execute the request. For example, if target agent 17 decodes a request to write to memory, target agent 17 will then execute software code corresponding to the request in order to instruct target processor 21 to take the requested action. For each request supported in the protocol, the corresponding code must be included in the respective device. Thus, by selecting the important requests for particular functions, a developer may minimize the software code required to execute the requests needed for the functions.

However, because the format of data structure 50 allows for the identification of an essentially unlimited number of commands, the protocol may be extended by a user to include additional requests and/or replies. This extension may be carried out by simply identifying a unique bit code for the request and/or reply and including the software code for the request/reply in the appropriate location. Once again, since memory space and processing power on target devices is at a premium, the protocol according to the present invention allows the user to most judiciously allocate memory to request/reply extensions that the individual user believes are important to the functions required by the user.

The protocol of the present invention is also extensible to support communication with multi-core targets, which are targets having more than one processor or a single processor with more than one operating mode. For example, a target device may include a Digital Signal Processor (“DSP”) and a Reduced Instruction Set Computing (“RISC”) processor. As described above, the protocol of the present invention may include subcodes for each of the requests. These subcodes may include information that identifies the processor, mode, agent or software object for which the protocol message is intended. In this manner, a single target agent may function for multiple processors or multiple modes. In a more general sense, a request subcode may contain an object identifier that is used to help route the protocol message to appropriate processing software. Thus, when the object identifier is nonzero, it may be used to identify multiple processor cores or multiple software agents for target device 20 by invoking routing functionality available to target agent 17.

The following describes a specific exemplary embodiment of protocol messaging according to the present invention where the protocol messaging is used for a debugging tool or program. The description will refer to the arrangement of FIG. 1 where it may be considered that tool 11 is a debugging program and the protocol messages may be considered in the format of data structure 50 of FIG. 3a. Initially, as shown in Table 1, an exemplary set of requests are defined that may be important for carrying out the debugging functions and upon which other higher level debugging functions can be built. Exemplary replies to these requests may also be included in the description.

TABLE 1

| | |
|---|---|
| Request/Event | Brief Description |

Session Management

| | |
|---|---|
| PING | Check if target is responding |
| CONNECT | Initiate connection to target agent |

Memory Operations

| | |
|---|---|
| READMEM | Read from target device memory |
| WRITEMEM | Write to target device memory |

Register Operations

| | |
|---|---|
| READREG | Read from target device register |
| WRITEREG | Write to target device register |

Target Control Operations

| | |
|---|---|
| HALT | Halt execution of target device |
| CONTINUE | Continue execution of target device |
| RESET | Reset target device |
| STEP | Perform instruction step of target device |
| COMMAND | Send vendor defined command to target agent |

Virtual I/O Operations

| | |
|---|---|
| VIO | Send I/O request/response to target device |
| | software |

Event Management

| | |
|---|---|
| ADDEVENT | Add new target device event to target agent |
| DELEVENT | Delete target device event from target agent |

Asynchronous Events from Target Agent

| | |
|---|---|
| EVT_DISCONNECT | Target agent requests a disconnect |
| EVT_BREAKPOINT | Target device encountered a breakpoint |
| EVT_SIGNAL | Target device or emulator encountered a signal |
| EVT_MODECHANGE | Target device or emulator experienced a mode |
| | change |
| EVT_MESSAGE | Target agent or emulator has a message |
| EVT_VIO | Target device software has an I/O request |

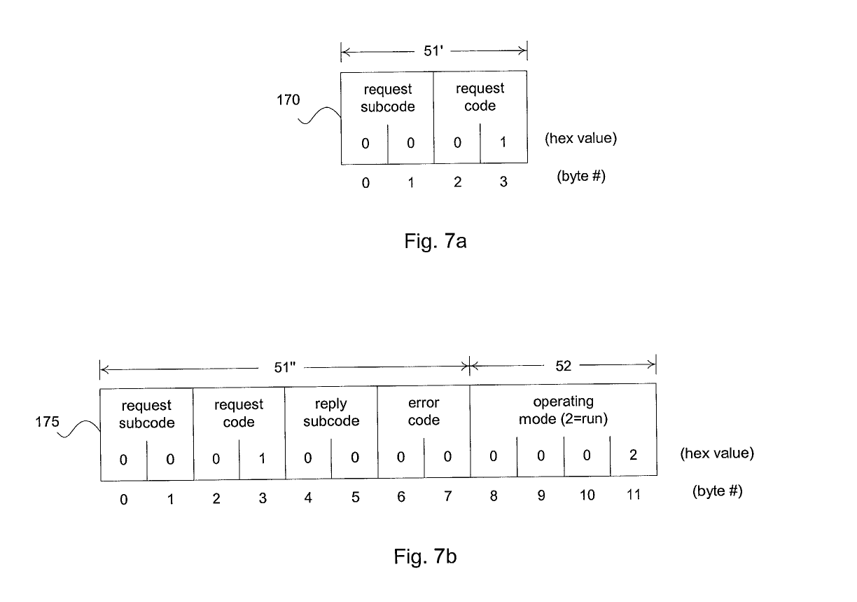

The first subset of requests relates to session management. A ping request checks to see whether target agent 17 is responding, and if so, retrieves the target device or emulator operating mode. Debugging tool 11 desires to know whether target agent 17 is responding so that it may send additional debug requests. Debugging tool 11 sends this information to target server 15 to format a protocol request. FIG. 7a shows an exemplary protocol request 170 for a ping request. Protocol request 170 is in the format of data structure 50 and only requires request header 51′ having request subcode (00) and request code (01). Target agent 17 receives and decodes protocol message 170, determines that it is a ping request and executes the software code corresponding to a ping request. If target agent is operating correctly, it formats a reply to protocol request 170.

FIG. 7b shows an exemplary protocol reply 175 to a ping request. Protocol reply 175 is also in the format of data structure 50 where reply header 51 contains the request subcode (00) and request code (01) corresponding to protocol request 170, reply subcode (00) and error code(00). The error code (00) indicates that the ping operation was successful and therefore, protocol reply 175 also includes the operating mode in fixed length data area 52 (e.g., run mode =0002 in hexadecimal). Operating modes may include, for example, running mode, debug mode, error mode, simulation mode, trace mode, etc. Target server 15 receives and decodes protocol reply 175 and reports the reply back to debugging tool 11. If target agent 17 is not responding, the request may timeout and target server 15 may generate an error (e.g., No Connection) indicating that there is no connection between target server 15 and target agent 17 or between target agent 17 and target device 20.

A connect request initiates the connection between the target server 15 and target agent 17. If successful, target agent 17 sends a reply indicating its implemented features and capabilities along with those of target device 20. Features that target agent 17 may implement include, for example, add/del breakpoints, single stepping, range stepping, processor independence (e.g., protocol does not run on target), protocol version, mtu, etc. If a connection cannot be established, the request may timeout and target server 15 may generate an error (e.g., No Connection) indicating that no connection could be established between target server 15 and target agent 17 or between target agent 17 and target device 20. A disconnect request initiates a disconnect between target server 15 and target agent 17.

The next subset of requests relate to memory operations for target device 20. A read memory request reads a given number of bytes from the memory of target device 20. A write memory request writes a given number of bytes to the memory of target device 20. An example of a successful write memory operation, including the streaming of data between target server 15 and target processor 21, was previously described. An exemplary error code that may be generated by target agent 17 to each of these requests may be an invalid address error indicating that the requested range of memory to read from or write to is outside the valid memory area.

The next subset of requests relate to register operations for target device 20. A register read request reads a given number of bytes from a specified register of target device 20. A register write request writes a given number of bytes to a specified register of target device 20. An example of a read register request was previously described. If the number of bytes to read or write is less than the register size, then the least significant bytes may be read or written. An exemplary error code that may be generated by target agent 17 to each of these requests may be an invalid register error indicating that the requested register identification cannot be processed by target agent 17. Another exemplary error code may be an invalid register size error indicating that the register size cannot be processed by target agent 17. The protocol messages of the present invention are hardware independent. However, there may be specific requests such as read/write register where target specific information (e.g., register identifier) is used.

The next subset of requests relate to the control of operations for target device 20. A halt request stops the execution of the software on target device 20. If successful, the reply to a halt request may include the program counter. A continue request continues the execution of the software on target device 20 at a specified memory address. A reset request forces a reset of target device 20 and leaves target processor 21 in a halted state. The reset may be a soft reset that only refreshes the parts of memory necessary for a working target. A step request may be either a single instruction step or a range step of target device 20 with interrupts disabled, either of which returns the value of the program counter at the end of the step. The step request may only be available if target agent 17 indicated that these requests were supported when the connection was established. Thus, an exemplary error code that may be generated by target agent 17 to a step request may be an unsupported request error.

A command request sends a vendor command to target agent 17. Vendor commands provide general-purpose extensions to the message protocol that allow sending a request packaged in the form of variable length data area 53 and receiving a reply also packaged as variable length data. Examples of such vendor commands may include activating or initializing flash memory algorithms, requesting upload of vendor-defined diagnostic information, invoking target device maintenance routines, invoking kernel aware debugging functions, querying the target agent for extended capabilities, etc. As discussed previously, any such request extensions require the corresponding software code to be included in the target agent. The maximum total size in bytes of a complete command request message, packaged in the format of data structure 50, may be limited to the mtu size designated when the target agent connection is made, thus eliminating any target agent requirement to dynamically allocate memory. Options provided with the command request indicate whether variable length reply data should be captured or ignored. An exemplary reply to a command request may include a valid size for the result data block so that either the result data or an error message may be retrieved. In the event that the result should be ignored, the valid size may be zero. Exemplary error codes may include an invalid command error indicating the vendor command is unsupported or it has invalid parameters, an invalid command size error indicating the command request is greater than the supported size for command (described above) or a command fail error indicating the command resulted in an error condition.

The next subset of requests relate to virtual input/output (“virtual I/O”) operations for target device 20. Virtual I/O allows target device 20 application software to multiplex any number of buffered, serial byte-stream-oriented I/O operations for multiple virtual channels over the single debug communication channel. Virtual I/O operations are supported jointly by the target server 15 and target agent 17 in combination with I/O support software on target device 20. A virtual I/O request sends an I/O related message, typically a response to a previous target device I/O event described below, to the target agent 17 which then relays the I/O message to target device I/O support software. Virtual I/O request messages encapsulate detailed I/O operation codes and associated I/O data and status within a variable length data element 53 of data structure 50. Virtual I/O support software resident on target device 20 in conjunction with the corresponding virtual I/O software of target server 15 may define and interpret the specific nature and meaning of the encapsulated I/O operation codes, data and status. As an example, I/O operation codes may specify the following functions for a virtual I/O channel: open, close, read, write, ioctl (special control functions), remove (a file) and query (for pending I/O operations). Target agent 17 simply relays the virtual PO events and requests containing these codes and related data between the target server 15 and target device 20.

A single virtual I/O operation may initiate a sequence of transactions between target server 15 and target device 20. For example, an “open” operation may begin with the target device 20 software initiating a virtual I/O event to indicate that an “open” operation was desired. This event may be detected by the target agent 17 and sent to the target server 15 via an asynchronous event message (described in greater detail below). Upon receiving the event message, target server 15 may determine whether it was an I/O event that contained a nonzero variable length data area 53 describing the I/O operation. Such a variable length data area 53 may include the “open” I/O operation code, related open parameters, the size of the target device I/O buffer, etc. If no data were provided with the I/O event, for example, if the target device software raised the I/O event via breakpoint, then target server 15 would send a virtual I/O request to query target device 20 for pending I/O operations and associated data. When target server 15 has obtained the I/O operation data, it will perform the requested I/O function and return the response to target device 20 in the form of a virtual I/O request that includes an appropriate I/O operation code.

The next subset of requests relate to event management for target device 20. An add event request adds a new event to target device 20. The reply to an add event request may include a unique event identification given by target agent 17. A commonly added event is a breakpoint at a given address. The unique identification in a reply to an add event request when the event is a breakpoint, may be the breakpoint address. Similarly, a delete event request deletes an event from target device 20. The add and delete event requests may only be available if target agent 17 indicates that these requests are supported when the connection is established. Exemplary error codes may include an unsupported request error indicating target agent 17 does not support event requests or an invalid address error indicating the requested address is outside the valid memory area.

The final subset of requests relate to asynchronous event notification from target agent 17 to target server 15. These events are essentially unsolicited messages from target agent 17 indicating events that are occurring at target device 20. Examples of asynchronous events include a disconnect event, a breakpoint event, a signal event, a mode change event, a message event, an input/output event, etc. Target agent 17 indicates these events to target server 15 because debugging tool 11 may require notification of these events in performing its associated functions. All event messages may use the same format as a reply message. That is, events are sent using the format of data structure 50 containing reply header 51″. With the exception of input/output operations, event messages do not require a response from target server 15. As described previously with reference to virtual I/O operations, input/output events may initiate a sequence of related request/reply transactions between target server 15 and target agent 17 that are needed to complete an input/output operation.

As described above, these exemplary requests and their related error codes may be a set of requests that encompass the messaging required for the operation of a host based debugging tool for a target device. The protocol of the present invention (e.g., messages in the format of data structure 50) provides for all communication between the host device and target device for debugging purposes even where the mtu of the target agent is relatively small. The protocol of the present invention allows for the exchange of large quantities of information without overloading the minimal resources of the target device. A developer that carefully selects a basic set of requests (e.g., the set of requests described above for debugging purposes) may be able to implement a very small and efficient target agent because the software code to decode messages and execute the corresponding commands may be minimal. Additionally, if a particular user or developer wants to include additional messaging capabilities through the adding of new commands or the addition of subcodes for the existing commands, the protocol of the present invention can be extended to accommodate such extension. The protocol according to the present invention has no unnecessary overhead in messaging allowing for an efficient use of the bandwidth available between the communicating devices.

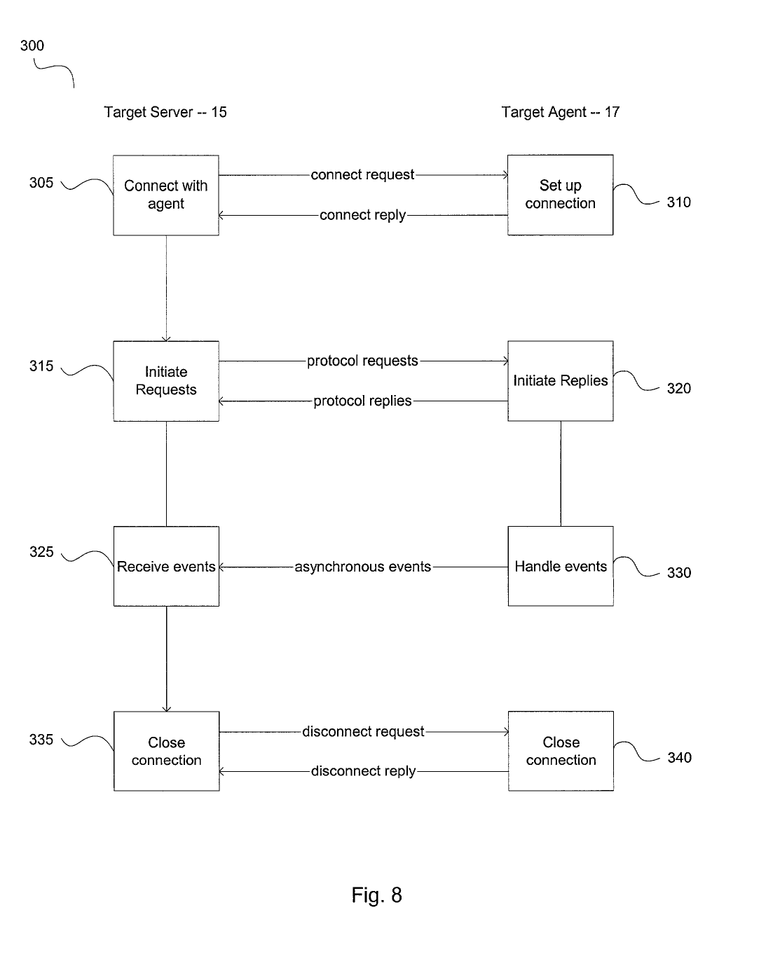

FIG. 8 shows a block diagram of an exemplary messaging session 300 between target server 15 and target agent 17. In the first block 305, target server 15 desires to connect to target agent 17 and formats a connect request which is encoded and sent to target agent 17. The connect request is received and decoded by target agent 17 which executes the corresponding code to set up the connection and formats and encodes a connect reply in block 310. The reply may include the implemented features and capabilities of target agent 17 along with those of the target device. After the connection is established, target server 15 may initiate a series of protocol requests including, for example, the requests described above for debugging (e.g., read/write memory, read/write register, etc.). In block 315, target server 15 formats a protocol message for each of the requests and sends the protocol request to target agent 17. In block 320, target agent 17 decodes the protocol requests, executes the code corresponding to the protocol request and formats a protocol reply to be sent back to target server 15. The protocol reply may include information based on the request, it may be a simple acknowledgment that the request was fulfilled or it may be an error code indicating a problem with the request or fulfilling the request. Target server 15 receives the reply and reports it back to the requesting tool. Session 300 may also include events that are generated by the target device. These events are handled by target agent 17 in block 330. Target agent formats an asynchronous reply and sends it to target server 15 which receives the event in block 325. Target server 15 then reports the event to the tools which may desire the event information.

When the connection between target server 15 and target agent 17 is no longer in use, target server 15 formats a disconnect request which is encoded and sent to target agent 17 in block 335. The disconnect request is received and decoded by target agent 17 which executes the corresponding code to close the connection and formats and encodes a disconnect reply in block 340. The connection is then closed and target server 15 may reconnect with target agent 17 or connect with a new target agent. Similarly, target agent 17 may wait for a connect request from any target server.

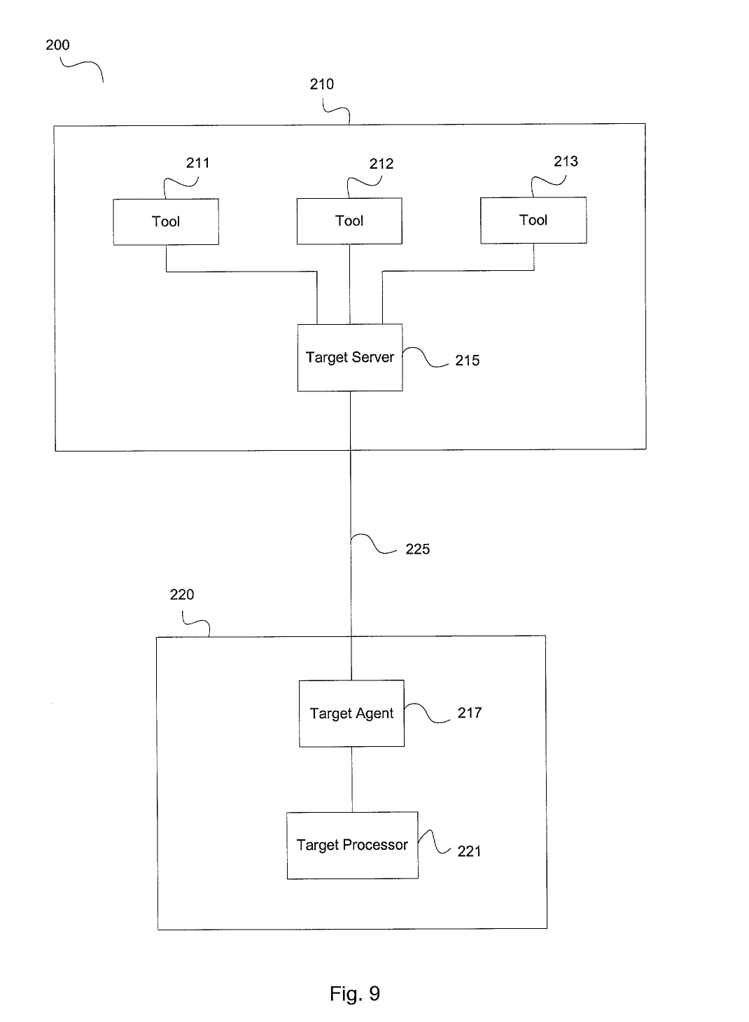

FIG. 9 shows a second exemplary arrangement 200 for communicating between host device 210 and target device 220. In the exemplary embodiment of FIG. 1, target agent 17 resided on the host device 10. In the exemplary embodiment of FIG. 9, target agent 217 resides on target device 220 and communication between target server 215 and target agent 217 is via communication link 225 (e.g., an ethernet or serial connection). As described above, whether target agent 217 resides on host device 210 or on target device 220, the communication between target agent 217 and target server 215 is essentially communication between target device 220 and host device 210 because target agent 217 has a direct connection to target processor 221. When the target agent (e.g., target agent 217) resides directly on target device 220, the requested action will be taken directly by target processor 221 because the software for target agent 217 is being executed by target processor 221 (as opposed to using specialized debugging functions). In exemplary arrangement 200 where target agent 217 resides on target device 220, the need for a small, efficient target agent is paramount because of the limited resources available on target device 220. Target agent 217 should have the smallest mtu possible and be loaded with minimal software code to execute commands, but still be able to send and receive messages bound for tools 211-213 in order for these tools to accomplish their functions. As described above, the protocol according to the present invention allows target agent 217 to remain small and efficient.

The protocol according to the present invention may also be used when the target device is a virtual target simulator meaning there is no actual target device. The virtual target simulator may be a full state machine that is resident on the host device that simulates the operation of the target device in every manner, such as the VxSim™ simulation environment provided as part of the Tornado® IDE. Thus, there is still a need for communication between the target server and the target agent. However, instead of directing a target processor to take the requested action, the target agent will direct the virtual simulator to simulate the requested action and report back the result of the simulated action.

The protocol of the present invention may also be applied to a variety of target device diagnostic and calibration situations. For example, some application programs must run on the target device continuously for long periods of time. Program errors for these types of application programs may only become evident after an extended period of operation. Detecting such errors often requires the developer to communicate with a running target device and retrieve diagnostic information from target device memory, which is a primary function of the described protocol. Furthermore, other embedded applications may require the developer to observe operational parameters being continuously stored in the memory of a running target device. Based on these observations, the developer may then calibrate or change selected parameters in the memory of the running target device for the purpose of tuning application program performance.

The protocol defined by the present invention may also be used for a variety of target device maintenance operations. These operations may be particularly relevant for target devices with flash memory. For example, after an embedded application is put into service, the need may arise to communicate with the target device to load new software routines into target device memory or otherwise patch the existing application program. This may typically require communicating with and controlling the target device at the instruction level for the purpose of activating flash memory writing algorithms or other maintenance routines.

In the preceding specification, the present invention has been described with reference to specific exemplary embodiments thereof. It will, however, be evident that various modifications and changes may be made thereunto without departing from the broadest spirit and scope of the present invention as set forth in the claims that follow. The specification and drawings are accordingly to be regarded in an illustrative rather than restrictive sense.

What is claimed is:

1. A system, comprising:
a target server configured to receive a request from a software tool and format a protocol request corresponding to the request, the protocol request including a request fixed length leader having a predetermined maximum size; and
a target agent configured to receive the protocol request from the target server into a communication buffer and send an instruction to a target processor to perform a function corresponding to the request, wherein the communication buffer is one of equal to and larger than the predetermined maximum size.

2. The system of claim 1, wherein the target agent formats a protocol reply in response to the protocol request, the protocol reply including a reply fixed length leader having a predetermined maximum size substantially equal to the predetermined maximum size of the request fixed length leader and including a status of the request.

3. The system of claim 2, wherein the target agent receives an indication of the status of the request from the target processor.

4. The system of claim 2, wherein the protocol reply further includes information responsive to the request.

5. The system of claim 1, wherein the target server encodes the protocol request and the target agent decodes the protocol request.

6. The system of claim 5, wherein the encoding is External Data Representation encoding.

7. The system of claim 1, wherein the protocol request includes a request code corresponding to the request and the target agent includes information to determine the correspondence between the request code and the request.

8. The system of claim 1, wherein the protocol request includes a data item indicating a size of information to be streamed from the target server to the target processor.

9. The system of claim 1, wherein the protocol request is communicated via a serial byte stream communication channel.

10. The system of claim 1, wherein the software tool includes one of a software loader/launcher, a debugger, a command line interface shell, a browser, a calibration tool, and a maintenance tool.

11. A method, comprising the steps of:
formatting a protocol request corresponding to a request from a software tool, the protocol request including a request code corresponding to the request;
transmitting the protocol request;
receiving the protocol request;
determining the request from the request code; and
instructing a target processor to take an action based on the request.

12. The method of claim 11, further comprising the step of:
formatting a protocol reply in response to the protocol request, the protocol reply including an error code indicating a status of the request.

13. The method of claim 12, wherein the protocol reply includes information responsive to the request.

14. The method of claim 12, further comprising the steps of:
transmitting the protocol reply;
receiving the protocol reply;
determining the status of the request from the protocol reply; and
indicating to the software tool the status of the request.

15. The method of claim 11, wherein the protocol request includes a fixed length data area which includes information corresponding to the request.

16. The method of claim 11, further comprising the step of:
transmitting streaming data in addition to the protocol request, wherein the protocol request includes an indication of a size of the transmitted streaming data.

17. The method of claim 11, wherein the transmitting step is performed by a target server.

18. The method of claim 11, wherein the receiving step is performed by a target agent including a communication buffer, the protocol request includes a request fixed length leader having a predetermined maximum size and the communication buffer is equal to the predetermined maximum size.

19. The method of claim 11, wherein the protocol request includes a request subcode which corresponds to one of the target processor, a mode, an agent and a software object for which the request is intended.

20. A system, comprising:
a target server configured to receive a plurality of requests from a software tool and format a protocol request for each of the received requests, the target server including a plurality of request codes corresponding to the plurality of requests, wherein the protocol request includes the request code corresponding to the received request; and
a target agent configured to receive the protocol request from the target server and send an instruction to a target processor to perform a function corresponding to the request, wherein the target agent includes information to correlate the request code to the corresponding request.

21. The system of claim 20, wherein the target agent includes a communication buffer which is substantially equal in size to a predetermined maximum size of a request fixed length leader of the protocol request.

22. The system of claim 20, wherein the plurality of requests are used to obtain one of debugging information, diagnostic information, calibration information and maintenance information from the target processor.

23. The system of claim 20, wherein the plurality of protocol requests are multiplexed over a serial byte stream communication.

24. A system, comprising:
a software tool issuing a request;
a target server configured to receive the request and format a protocol request corresponding to the request, the protocol request including a request fixed length leader having a predetermined maximum size; and
a target agent configured to receive the protocol request from the target server into a communication buffer and send an instruction to a target processor to perform a function corresponding to the request, wherein the communication buffer is one of equal to and larger than the predetermined maximum size.

25. A system, comprising:
a request module configured to format a protocol request including a request fixed length leader having a predetermined maximum size; and
a target module configured to receive the protocol request from the request module into a communication buffer, wherein the communication buffer is one of equal to and larger than the predetermined maximum size.
